(19) United States
(12) Patent Application Publication
(10) Pub. No.: US 2026/0301331 A1
(43) Pub. Date: Oct. 1, 2026

(54) SYSTEMS, METHODS, AND COMPUTER PROGRAM PRODUCTS FOR RENDERING A PARTIAL BOUNDARY OF A VIRTUAL SPACE

(71) Applicant: Lenovo (United States) Inc., Morrisville, NC (US)

(72) Inventors: Alec Hoffmann, Cary, NC (US); Hassan Mahini, Cary, NC (US); Andrew Hansen, Raleigh, NC (US)

(21) Appl. No.: 19/094,626

(22) Filed: Mar. 28, 2025

(51) Int. Cl. G06T 19/00; G02B 27/01

(52) U.S. Cl. CPC G06T 19/006; G02B 27/017

(57) ABSTRACT

Systems, methods, and computer program products that render a partial boundary of a mixed reality virtual space are disclosed. One system includes an apparatus including a processor and a memory coupled to the processor. The memory includes instructions executable by the processor to cause the apparatus to display a virtual object proximate to a boundary of a virtual space within a mixed reality environment and render an indicator representing the boundary over the virtual object in response to a user approaching the boundary. Here, the indicator is not rendered in the mixed reality environment beyond being rendered over the virtual object in response to the user approaching the boundary. Methods and computer program products that include and/or perform the operations and/or functions of the system, apparatus, and/or processor are also disclosed.

### FIELD

The subject matter disclosed herein relates to digital headsets and, more particularly, relates to systems, methods, and computer program products for rendering a partial boundary of a virtual space.

### DESCRIPTION OF THE RELATED ART

Boundary systems are used to protect a user of a contemporary fully immersive digital headset (e.g., virtual reality (VR) glasses, VR goggles, augmented reality (AR) glasses, AR goggles, etc.) from bumping into real objects that the user cannot see while using the digital headset. When these same boundary systems are applied to a contemporary mixed reality (MR) headset (e.g., MR glasses or MR goggles) or to contemporary VR glasses, VR goggles, AR glasses, or AR goggles operating in passthrough mode in which the user is able to see a combination of real surroundings and virtual content, a fully rendered boundary can become redundant and/or distracting with regards to safety compared to fully immersive digital headsets because the user is able to see for themself the real-world hazards in the surrounding environment.

### BRIEF SUMMARY

Systems that can render a partial boundary of a virtual space are disclosed. One system includes an apparatus including a processor and a memory coupled to the processor. The memory includes instructions executable by the processor to cause the apparatus to display a virtual object proximate to a boundary of a virtual space within a mixed reality environment and render an indicator representing the boundary over the virtual object in response to a user approaching the boundary. Here, the indicator is not rendered in the mixed reality environment beyond being rendered over the virtual object in response to the user approaching the boundary.

Also disclosed are methods that can render a partial boundary of a virtual space. One method includes displaying, by a processor on a headset, a virtual object proximate to a boundary of a virtual space within a mixed reality environment and rendering an indicator representing the boundary over the virtual object in response to a user approaching the boundary. Here, the indicator is not rendered in the mixed reality environment beyond being rendered over the virtual object in response to the user approaching the boundary.

Further disclosed herein are computer program products including a computer-readable storage device including code embodied therewith that can render a partial boundary of a virtual space. The code is executable by a processor and causes the processor to display, on a headset, a virtual object proximate to a boundary of a virtual space within a mixed reality environment and render an indicator representing the boundary over the virtual object in response to a user approaching the boundary. Here, the indicator is not rendered in the mixed reality environment beyond being rendered over the virtual object in response to the user approaching the boundary.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIGS. 1A and 1B are schematic block diagrams of various embodiments of a digital headset;

FIG. 2 is schematic block diagram of one embodiment of a memory device included in the digital headsets of FIGS. 1A and 1B;

FIG. 3 is schematic block diagram of one embodiment of a processor included in the digital headsets of FIGS. 1A and 1B;

FIGS. 4A and 4B are schematic block diagrams of various embodiments of a set of mixed reality (MR) glasses and/or MR goggles;

FIG. 5 is schematic block diagram of one embodiment of a memory device included in the MR glasses/MR goggles of FIGS. 4A and 4B;

FIG. 6 is schematic block diagram of one embodiment of a processor included in the MR glasses/MR goggles of FIGS. 4A and 4B;

FIGS. 7A and 7B are schematic block diagrams of various embodiments of a set of virtual reality (VR) glasses and/or VR goggles;

FIG. 8 is schematic block diagram of one embodiment of a memory device included in the VR glasses/VR goggles of FIGS. 7A and 7B;

FIG. 9 is schematic block diagram of one embodiment of a processor included in the VR glasses/VR goggles of FIGS. 7A and 7B;

FIGS. 10A and 10B are schematic block diagrams of various embodiments of a set of augmented reality (AR) glasses and/or AR goggles;

FIG. 11 is schematic block diagram of one embodiment of a memory device included in the AR glasses/AR goggles of FIGS. 10A and 10B;

FIG. 12 is schematic block diagram of one embodiment of a processor included in the AR glasses/AR goggles of FIGS. 10A and 10B;

FIGS. 13A through 13C are diagrams illustrating operation of various embodiments of systems, methods, and computer program products that can render a partial boundary of a virtual space; and

FIGS. 14 through 16 are schematic flow chart diagrams illustrating various embodiments of a method that can render a partial boundary of a virtual space.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a circuit, module, or system. Furthermore, embodiments may take the form of a program product embodied in one or more computer-readable storage devices storing machine readable code, computer-readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together and may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer-readable storage devices. Where a module or portions of a module are implemented in software, the software portions are stored on one or more computer-readable storage devices.

Any combination of one or more computer-readable media may be utilized. The computer-readable medium/media may include one or more computer-readable storage media. The computer-readable storage medium/media may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (e.g., a non-exhaustive and/or non-limiting list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the C programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to one embodiment, an embodiment, or similar language means that a particular feature, structure, or characteristic described in connection with the embodiment is included in at least one embodiment. Thus, appearances of the phrases in one embodiment, in an embodiment, and similar language throughout this specification may, but do not necessarily, all refer to the same embodiment, but mean one or more but not all embodiments unless expressly specified otherwise. The terms including, comprising, having, and variations thereof mean including but not limited to, unless expressly specified otherwise. An enumerated listing of items does not imply that any or all of the items are mutually exclusive, unless expressly specified otherwise. The terms, “a,” “an,” and “the,” also refer to one or more unless expressly specified otherwise.

In addition, as used herein, the term, “set,” can mean one or more, unless expressly specified otherwise. The term, “sets,” can mean multiples of or a plurality of one or mores, ones or more, and/or ones or mores consistent with set theory, unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatus, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

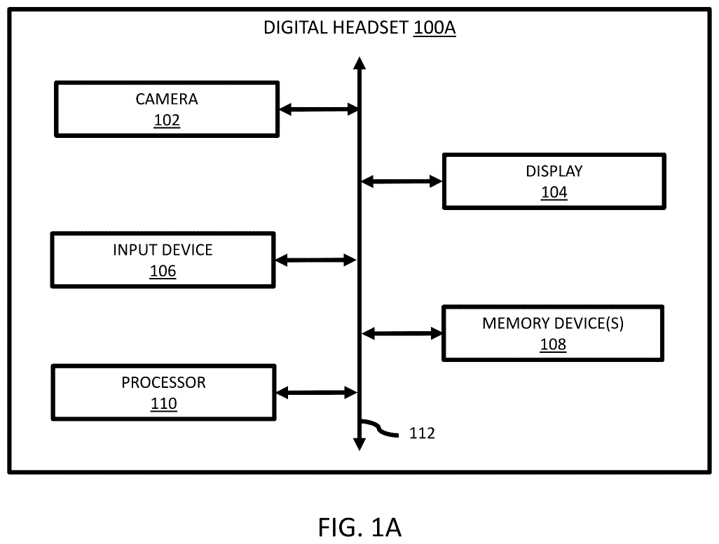

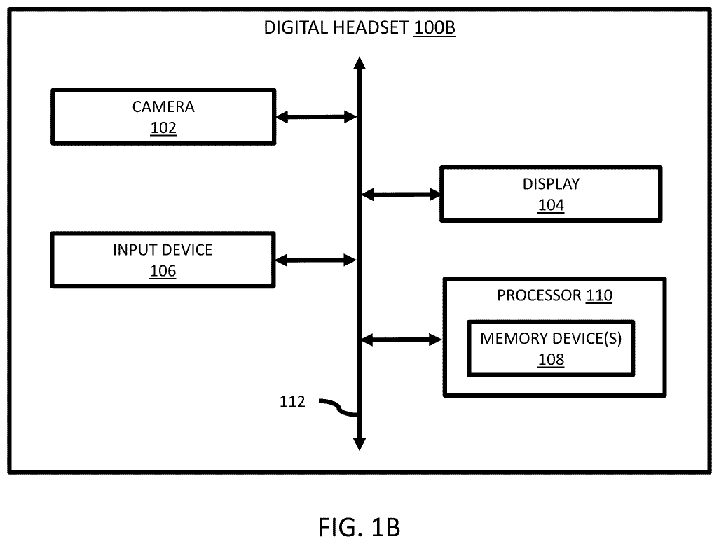

With reference to FIG. 1A, FIG. 1A is a block diagram of one embodiment of a digital headset 100A that can render a partial virtual boundary of a virtual space and/or safe space. In certain embodiments, a digital headset 100A includes mixed reality (MR) goggles or MR glasses. In additional or alternative embodiments, a digital headset 100A includes virtual reality (VR) goggles, VR glasses, augmented reality (AR) goggles, or AR glasses that are capable of operating in a mode (e.g., passthrough mode) that allows/enables the user to view their real-world surroundings while wearing/using the VR goggles, VR glasses, AR goggles, or AR glasses. As such, a digital headset 100A can include dedicated MR devices and non-dedicated MR devices that are capable of at least temporarily operating and/or functioning as MR devices and/or similar to MR devices.

At least in the illustrated embodiment, the digital headset 100A includes, among other components, a camera 102, a display 104, an input device 106, a set of one or more memory devices 108, and a processor 110. The camera 102, display 104, input device 106, set of one or more memory devices 108, and processor 110 are coupled to and/or in communication with one another via a bus 112 (e.g., a wired and/or wireless bus).

A camera 102 may include any suitable device that is known or developed in the future capable of capturing real-world content in the environment surrounding the digital headset 100A and/or camera 102 and transmitting images, video feeds, and/or video streams of the real-world content in the environment surrounding the digital headset 100A and/or camera 102 to the display 104. In various embodiments, the camera 102 includes at least one video camera. In additional or alternative embodiments, the camera 102 includes an external facing camera.

In some embodiments, the digital headset 100A can utilize a passthrough mode so that the user can visualize the real-world environment using the user's vision. As such, in various embodiments, the camera 102 can be omitted.

In various embodiments, the real-world environment can include one or more real-world objects, which can also be referred to as real-world items. Real-world objects can include any type of object that can exist in the real world that is known or developed in the future. In various embodiments, a real-world object can include an analog object and/or a digital object. In certain embodiments, a real-world environment can include one or more objects that can serve as one or more visual cues for defining a boundary for a virtual space and/or safe space within the real-world environment, as discussed elsewhere herein.

A display 104 may include any suitable device that is known or developed in the future capable of displaying the images, video feeds, and/or video streams. In certain embodiments, the display 104 includes an internal display of the digital headset 100A.

In various embodiments, the display 104 is configured to display a mixed-reality environment that includes the real-world content and virtual content. That is, the display 104 is configured to display the real-world object(s) captured by the camera 102 (e.g., real-world content) along with one or more virtual objects and/or one or more virtual items (e.g., virtual content).

In various embodiments, the display 104 is configured to at least temporarily render a portion of a virtual boundary (or partial virtual boundary) representing an area of the boundary for the virtual/safe space. In certain embodiments, the display 104 is configured to temporarily render a portion of the virtual boundary in response to the user (e.g., via detection of a current location of the digital headset 100A) approaching the boundary and/or coming within a predetermined distance of the boundary, which predetermined distance can be any suitable distance and in which temporarily rendering can include any suitable amount of time. In other embodiments, the display 104 is configured to render a portion of the virtual boundary in response to the user approaching the boundary and/or coming within the predetermined distance of the boundary for the entire time that the user is within the predetermined distance of the boundary.

In accordance with various embodiments, a portion of the virtual boundary is rendered over at least a portion of virtual object and not rendered in or over the other areas/portions of the user's viewable area and/or field of view in response to the user approaching the boundary and/or coming within the predetermined distance of the boundary. That is, the virtual boundary is not rendered outside and/or beyond the border/borders of the virtual object in response to the user approaching the boundary and/or coming within the predetermined distance of the boundary. For understanding and not to limit the various embodiments and/or the scope thereof, the virtual boundary can be considered as only being rendered over an entirety of the virtual object or a portion of the virtual object and not rendered anywhere else within the user's viewable area and/or field of view in response to the user approaching the boundary and/or coming within the predetermined distance of the boundary.

An input device 106 may include any suitable device that is known or developed in the future capable of receiving one or more user inputs. In various embodiments, the input device 106 includes a button and/or a microphone, etc., among other suitable input devices that are possible, each of which is contemplated herein.

A set of memory devices 108 may include any suitable quantity of memory devices 108. Further, a memory device 108 may include any suitable type of device and/or system that is known or developed in the future that can store computer-useable and/or computer-readable code. In various embodiments, a memory device 108 may include one or more non-transitory computer-usable mediums (e.g., readable, writable, read/write, etc.), which may include any non-transitory and/or persistent apparatus or device that can contain, store, communicate, propagate, and/or transport instructions, data, computer programs, software, code, routines, etc., for processing by or in connection with a computer processing device (e.g., a processor 110A).

A memory device 108, in some embodiments, includes volatile computer storage media. For example, a memory device 108 may include random access memory (RAM), including dynamic RAM (DRAM), synchronous dynamic RAM (SDRAM), and/or static RAM (SRAM). In other embodiments, a memory device 108 includes non-volatile computer storage media. For example, a memory device 108 may include a hard disk drive, a flash memory, and/or any other suitable non-volatile computer storage device that is known or developed in the future. In various embodiments, a memory device 108 includes both volatile and non-volatile computer storage media.

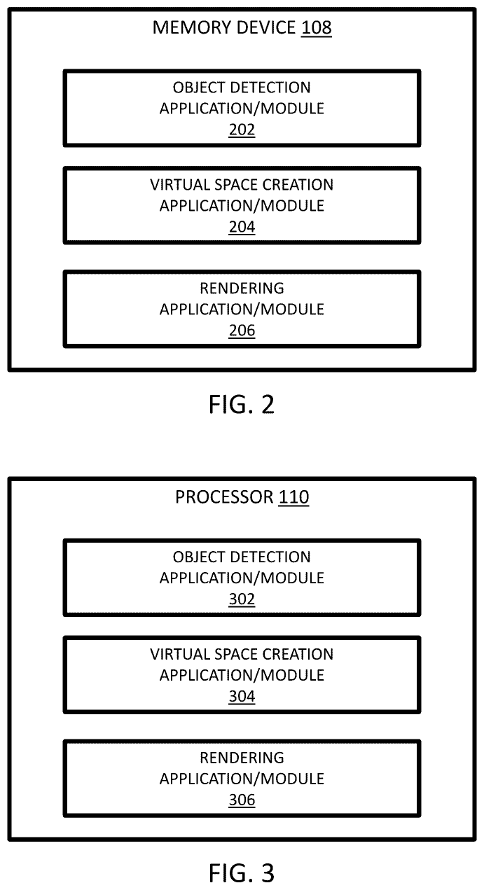

With reference now to FIG. 2, FIG. 2 is a schematic block diagram of one embodiment of a memory device 108. At least in the illustrated embodiment, the memory device 108 includes, among other components, an object detection application and/or module 202, a virtual space creation application and/or module 204, and a rendering application and/or module 206 that are each configured to operate/function when executed by a processor 110.

An object detection application/module 202 may include any suitable hardware and/or software that can sense and/or detect real-world objects (e.g., analog object(s) and/or digital object(s)) in a real-world environment surrounding the digital headset 100A and/or camera 102. In various embodiments, the object detection application/module 202 is configured to utilize the camera 102 to sense/detect the location and/or relative position of each real-world object (e.g., one or more real-world objects) in the real-world environment surrounding the digital headset 100A and/or camera 102. The location and/or relative position of each real-world object in the real-world environment surrounding the digital headset 100A and/or camera 102 can be sensed/detected using any suitable technique and/or method that is known or developed in the future.

A virtual space creation application/module 204 may include any suitable hardware and/or software that can create a virtual space, safe space, and/or virtual perimeter within a real-world environment. A virtual space or safe space may include any suitable type of virtual/safe space that is known or developed in the future.

In some embodiments, the virtual space creation application/module 204 is configured to automatically (e.g., without user input) and/or automatedly (e.g., without user interaction) create a virtual space. Here, the virtual space creation application/module 204 can receive the digitally determined and/or mapped real-world environment from the object detection application/module 202 and create a boundary and/or set of boundaries (e.g., virtual boundary/boundaries) that define(s) the virtual space(s) within the real-world area.

The virtual space creation application/module 204, in further embodiments, is configured to create and/or include one or more virtual objects along and/or at/proximate to the boundary/boundaries of the virtual space. A virtual object may include any suitable virtual object and/or type of virtual object that is known or developed in the future.

A rendering application/module 206 may include any suitable hardware and/or software that can render a portion of a virtual boundary representing the boundary of a virtual/safe space and/or render a partial virtual boundary representing the boundary virtual/safe space. In various embodiments, the rendering application/module 206 is configured to render the portion of the virtual boundary and/or partial virtual boundary on the display 104 in response to the user (or the digital headset 100A) approaching the boundary of the virtual/safe space. The rendered portion of the virtual boundary and/or partial virtual boundary, in various embodiments, may include any suitable virtual boundary, type of virtual boundary, cue, and/or type of cue that is known or developed in the future.

In various embodiments, a virtual boundary/boundary type for which a portion of which is rendered can include a grid or visual grid, among other virtual boundaries/virtual boundary types that are possible, each of which is contemplated herein. In some embodiments, the rendered partial grid/visual grid and/or the rendered portion of the grid/visual grid can include a safe space boundary grid.

A cue may include any suitable cue(s) that is/are known or developed in the future capable of notifying a user that the user is approaching a boundary of a virtual/safe space. In certain embodiments, a cue includes a visual cue. The visual cue, in various embodiments, may be set by a manufacturer and/or by a user of the digital headset 100A.

A visual cue, in some embodiments, includes a predetermined visual cue. The predetermined visual cue may include any suitable set of one or more visual cues that is/are known or developed in the future. Example visual cues can include, but are not limited to, a shape, a color, a light, a glow, a frequency, a magnitude, a texture, motion (e.g., movement, static, etc.), a size/scale, a dimension (e.g., length, width, height, depth, thickness, etc.), a symbol, a number, a letter, a word, a contrast, an icon, a gesture, and/or an orientation of such, etc., among other visual cues that are possible, each of which are contemplated herein.

In various embodiments, a user of the digital headset 100A can trigger and/or cause the predetermined visual cue to appear, come into view, and/or be displayed on the display 104 in response to the user approaching the boundary and/or coming within a predetermined distance of the boundary of a virtual/safe space. The predetermined visual cue can be caused to appear, come into view, and/or be displayed on the display 104 using any suitable technology, method, and/or technique that is known or developed in the future.

In some embodiments, the rendered portion of the virtual boundary and/or visual cue covers and/or is rendered over or behind an entirety of the virtual object located along and/or at/proximate to the boundary in response to the user approaching the boundary and/or being located within the predetermined distance of the boundary. In further, embodiments, multiple rendered portions of the virtual boundary and/or visual cue covers and/or is rendered over or behind an entirety of each virtual object located along and/or at/proximate to the boundary in response to the user approaching the boundary and/or being located within the predetermined distance of the boundary.

In additional or alternative embodiments, the rendered portion of the virtual boundary and/or visual cue covers and/or is rendered over a portion of the virtual object located along and/or at/proximate to the boundary in response to the user approaching the boundary and/or being located within the predetermined distance of the boundary. In additional, embodiments, multiple rendered portions of the boundary and/or visual cue cover and/or is/are rendered over multiple portions of the virtual object located along and/or at/proximate to the boundary in response to the user approaching the boundary and/or being located within the predetermined distance of the boundary. In further, embodiments, multiple rendered portions of the boundary and/or visual cue covers and/or is rendered over or behind one or more portions of each virtual object located along and/or at/proximate to the boundary in response to the user approaching the boundary and/or being located within the predetermined distance of the boundary.

In various embodiments, the virtual boundary and/or portions thereof are not rendered over areas of the boundary at which a virtual object and/or virtual item is not placed and/or located in response to the user approaching the boundary and/or being located within the predetermined distance of the boundary. Similarly, the visual cues and/or portions thereof are not rendered over areas of the boundary at which a virtual object and/or virtual item is not placed and/or located in response to the user approaching the boundary and/or being located within the predetermined distance of the boundary. Thus, the user is able to visually detect real-world object(s) along and/or at/proximate to the boundary at which no virtual object and/or virtual item is not placed and/or located via the user's own sight.

The partial virtual boundary and/or portion of the virtual boundary can be rendered for any suitable amount of time in response to the user approaching the boundary and/or being proximate to the boundary. In certain embodiments, the partial virtual boundary and/or portion(s) of the virtual boundary is/are constantly and/or consistently rendered in response to the user approaching the boundary and/or being located proximate to the boundary. In additional or alternative embodiments, the partial virtual boundary and/or portion(s) of the virtual boundary is/are temporarily rendered and/or rendered for a predetermined amount of time in response to the user approaching the boundary and/or being located proximate to the boundary, which predetermined amount of time can include any suitable amount of time that can enable the user to see the partial virtual boundary and/or the portion(s) of the virtual boundary and/or not be distracted by the partial virtual boundary and/or the portion(s) of the virtual boundary being rendered.

In addition, the rendering application/module 206 is configured to no longer render the partial virtual boundary and/or portion(s) of the virtual boundary in response to the user moving away from the boundary and/or no longer being at/proximate to the boundary. Alternatively, or additionally, the rendering application/module 206 is configured to no longer render the partial virtual boundary and/or the portion(s) of the virtual boundary in response to the expiration of a predetermined amount of time, which can be any suitable amount of time.

While multiple examples of technologies, techniques, and/or methods for causing a partial virtual boundary and/or visual cue to appear, come into view, and/or be displayed on the display 104 over a virtual object located along and/or at proximate to virtual/safe space boundary are presented above, the various embodiments are not limited by these examples. Rather, these examples are provided to assist in understanding the nature and principles of the various embodiments. As such, the nature and principles of the above examples can be applied by one skilled in the art beyond the specific examples provided herein in extrapolating the extent and/or scope of the various embodiments disclosed herein.

Referring back to FIG. 1A, a processor 110 may include any suitable non-volatile/persistent hardware and/or software configured to perform and/or facilitate performing various processing functions and/or operations. In various embodiments, the processor 110 includes hardware and/or software for executing instructions in an object detection application and/or module 202, a virtual space creation application and/or module 204, and a rendering application and/or module 206 (see, e.g., FIG. 2).

With reference to FIG. 3, FIG. 3 is a schematic block diagram of one embodiment of a processor 110. At least in the illustrated embodiment, the processor 110 includes, among other components, an object detection application and/or module 302, a virtual space creation application and/or module 304, and a rendering application and/or module 306 similar to the object detection application and/or module 202, virtual space creation application and/or module 204, and rendering application and/or module 206 stored on the storage device(s) 108 discussed with reference to FIG. 2. As such, the object detection application and/or module 202/302, virtual space creation application and/or module 204/304, and rendering application and/or module 206/306 executed by the processor 110 can be stored on and executed from a memory device 108 and/or from the processor 110.

Referring to FIG. 1B, FIG. 1B is a block diagram of another embodiment of a digital headset 100B. The digital headset 100B includes, among other components, a camera 102, a display 104, one or more input devices 106, one or more memory devices 108, and a processor 110 coupled to and/or in communication with one another via a bus 112, similar to the camera 102, display 104, input device(s) 106, memory device(s) 108, processor 110, and bus 112 discussed with reference to the digital headset 100A illustrated in and discussed with reference to FIG. 1A. Alternative to the digital headset 100A, the processor 110 in the digital headset 100B includes the memory device(s) 108 as opposed to the memory device(s) 108 of the digital headset 100A being a different device than and/or independent of the processor 110.

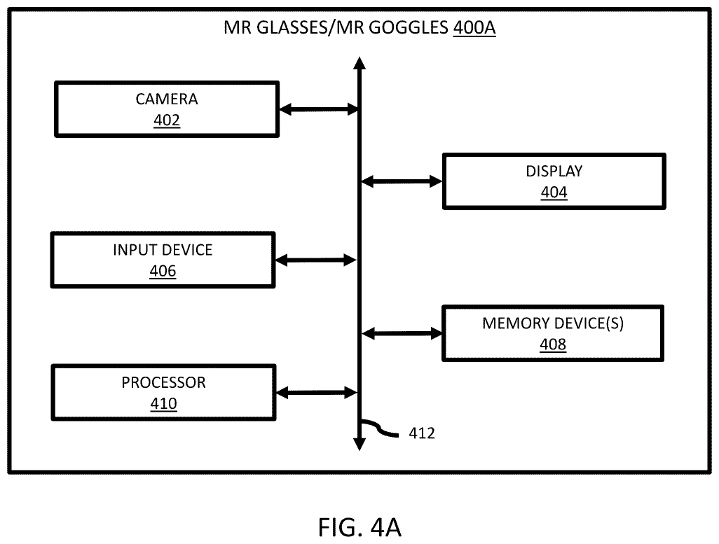

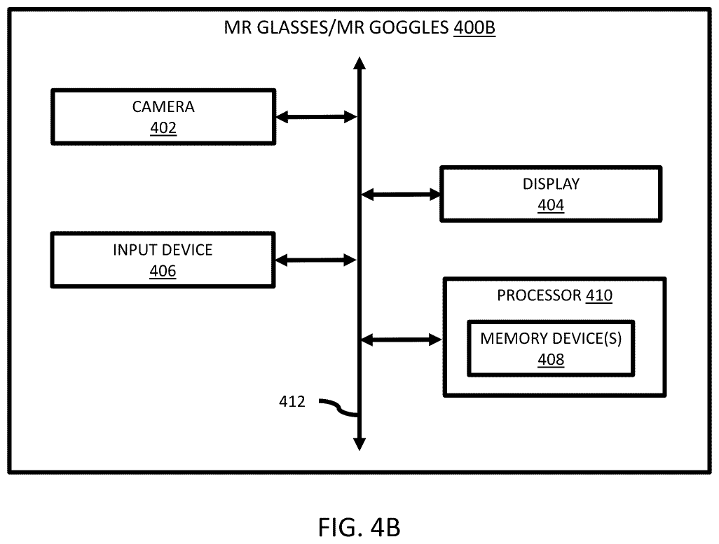

With reference to FIG. 4A, FIG. 4A is a block diagram of one embodiment of MR glasses and/or goggles 400A capable of operating/functioning in a passthrough mode. The MR glasses and/or goggles 400A include, among other components, a camera 402, a display 404, one or more input devices 406, one or more memory devices 408, and a processor 410 coupled to and/or in communication with one another via a bus 412, similar to the camera 102, display 104, input device(s) 106, memory device(s) 108, processor 110, and bus 112 discussed with reference to the digital headset 100A illustrated in and discussed with reference to FIG. 1A.

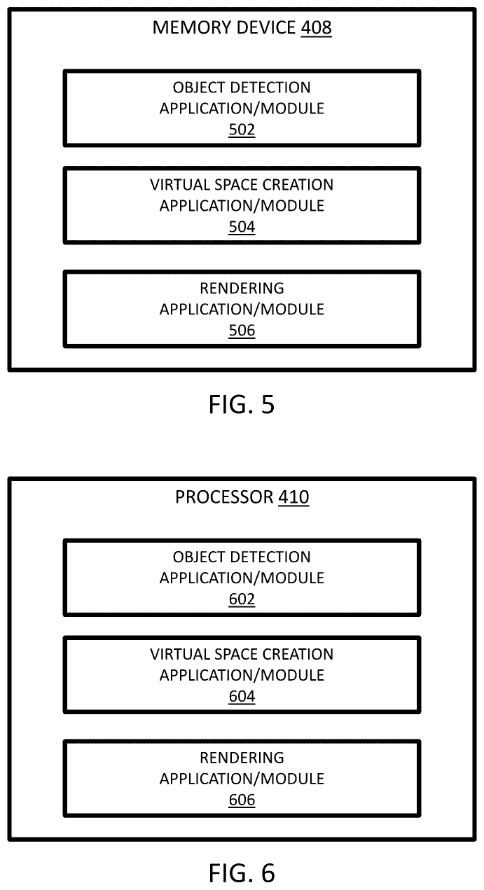

Referring to FIG. 5, FIG. 5 is a schematic block diagram of one embodiment of a storage device 408 included in the MR glasses and/or goggles 400A. At least in the illustrated embodiment, the storage device 408 includes, among other components, an object detection application and/or module 502, a virtual space creation application and/or module 504, and rendering application and/or module 506 similar to the object detection application and/or module 202, virtual space creation application and/or module 204, and rendering application and/or module 206 stored on the storage device(s) 108 discussed with reference to FIG. 2.

With reference to FIG. 6, FIG. 6 is a schematic block diagram of one embodiment of a processor 410 included in the MR glasses and/or goggles 400A. At least in the illustrated embodiment, the processor 410 includes, among other components, an object detection application and/or module 602, a virtual space creation application and/or module 604, and a rendering application and/or module 606 similar to the object detection application and/or module 302, virtual space creation application and/or module 304, and rendering application and/or module 306 stored on the processor 110 discussed with reference to FIG. 3. As such, the object detection application and/or module 502/602, virtual space creation application and/or module 504/604, and rendering application and/or module 506/606 executed by the processor 410 can be stored on and executed from a memory device 408 and/or from the processor 410.

With reference to FIG. 4B, FIG. 4B is a block diagram of another embodiment of MR glasses and/or goggles 400B capable of operating/functioning in a passthrough mode. The MR glasses and/or goggles 400B include, among other components, a camera 402, a display 404, one or more input devices 406, one or more memory devices 408, and a processor 410 coupled to and/or in communication with one another via a bus 412, similar to the camera 102, display 104, input device(s) 106, memory device(s) 108, processor 110, and bus 112 discussed with reference to the digital headset 100A illustrated in and discussed with reference to FIG. 1A. Alternative to the MR glasses/goggles 400A, the processor 410 in the MR glasses/goggles 400B includes the memory device(s) 408 as opposed to the memory device(s) 408 of the virtual reality glasses/goggles 400A being a different device than and/or independent of the processor 410.

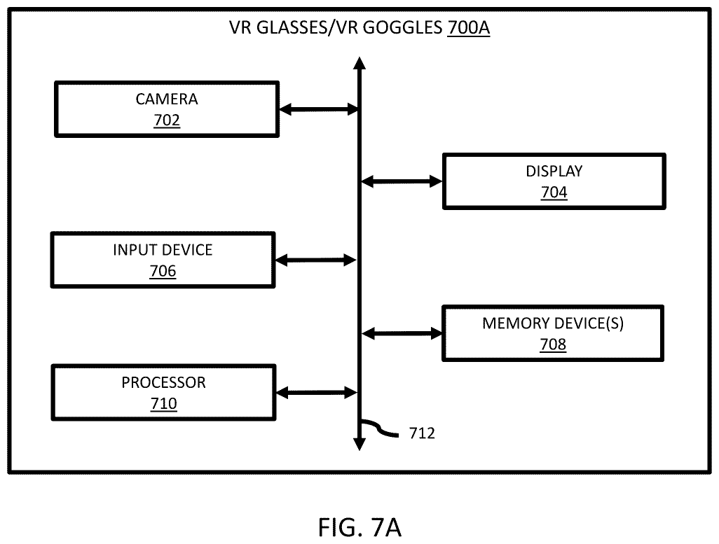

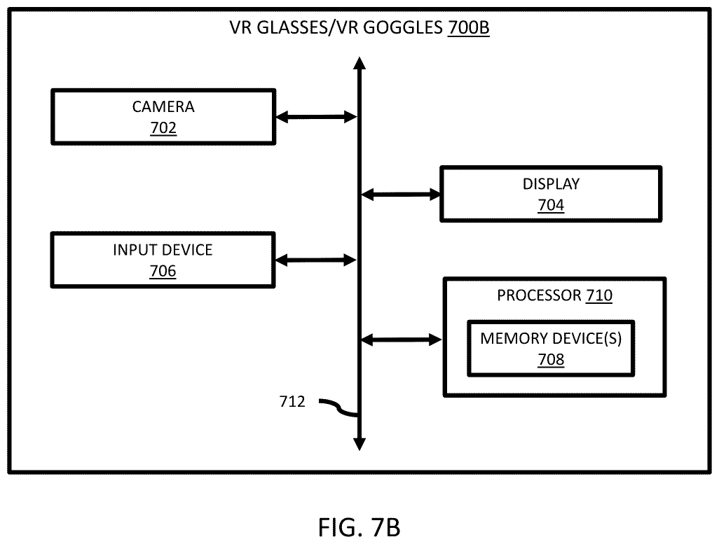

With reference to FIG. 7A, FIG. 7A is a block diagram of one embodiment of VR glasses and/or goggles 700A capable of operating/functioning in a passthrough mode. The VR glasses and/or goggles 700A include, among other components, a camera 702, a display 704, one or more input devices 706, one or more memory devices 708, and a processor 710 coupled to and/or in communication with one another via a bus 712, similar to the camera 102, display 104, input device(s) 106, memory device(s) 108, processor 110, and bus 112 discussed with reference to the digital headset 100A illustrated in and discussed with reference to FIG. 1A.

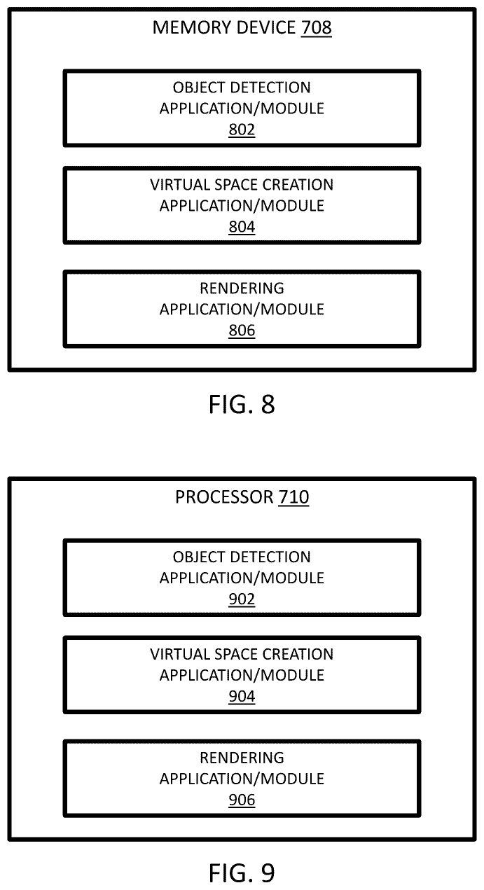

Referring to FIG. 8, FIG. 8 is a schematic block diagram of one embodiment of a storage device 708 included in the VR glasses and/or goggles 700A. At least in the illustrated embodiment, the storage device 708 includes, among other components, an object detection application and/or module 802, a virtual space creation application and/or module 804, and rendering application and/or module 806 similar to the object detection application and/or module 202, virtual space creation application and/or module 204, and rendering application and/or module 206 stored on the storage device(s) 108 discussed with reference to FIG. 2.

With reference to FIG. 9, FIG. 9 is a schematic block diagram of one embodiment of a processor 710 included in the VR glasses and/or goggles 700A. At least in the illustrated embodiment, the processor 710 includes, among other components, an object detection application and/or module 902, a virtual space creation application and/or module 904, and a rendering application and/or module 906 similar to the object detection application and/or module 302, virtual space creation application and/or module 304, and rendering application and/or module 306 stored on the processor 110 discussed with reference to FIG. 3. As such, the object detection application and/or module 802/902, virtual space creation application and/or module 804/904, and rendering application and/or module 806/906 executed by the processor 710 can be stored on and executed from a memory device 708 and/or from the processor 710.

With reference to FIG. 7B, FIG. 7B is a block diagram of another embodiment of VR glasses and/or goggles 700B capable of operating/functioning in a passthrough mode. The VR glasses and/or goggles 700B include, among other components, a camera 702, a display 704, one or more input devices 706, one or more memory devices 708, and a processor 710 coupled to and/or in communication with one another via a bus 712, similar to the camera 102, display 104, input device(s) 106, memory device(s) 108, processor 110, and bus 112 discussed with reference to the digital headset 100A illustrated in and discussed with reference to FIG. 1A. Alternative to the VR glasses/goggles 700A, the processor 710 in the VR glasses/goggles 700B includes the memory device(s) 708 as opposed to the memory device(s) 708 of the virtual reality glasses/goggles 700A being a different device than and/or independent of the processor 710.

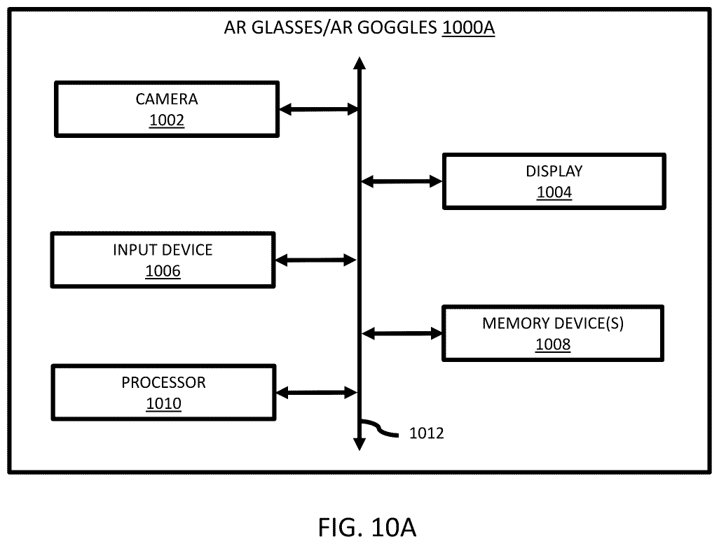

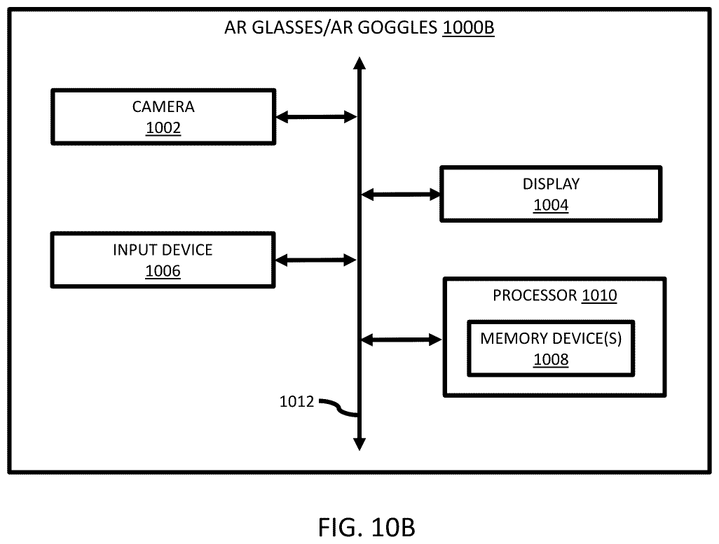

With reference to FIG. 10A, FIG. 10A is a block diagram of one embodiment of AR glasses and/or goggles 1000A capable of operating/functioning in a passthrough mode. The AR glasses and/or goggles 1000A include, among other components, a camera 1002, a display 1004, one or more input devices 1006, one or more memory devices 1008, and a processor 1010 coupled to and/or in communication with one another via a bus 1012, similar to the camera 102, display 104, input device(s) 106, memory device(s) 108, processor 110, and bus 112 discussed with reference to the digital headset 100A illustrated in and discussed with reference to FIG. 1A.

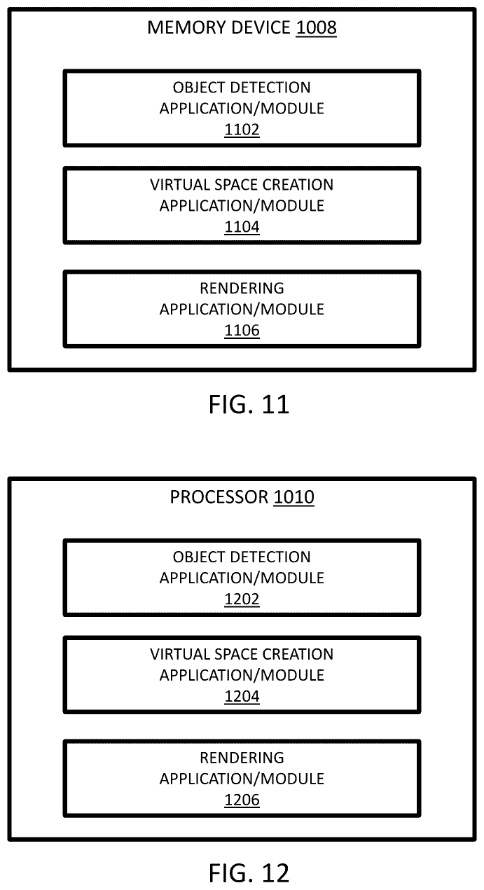

Referring to FIG. 11, FIG. 11 is a schematic block diagram of one embodiment of a storage device 1008 included in the AR glasses and/or goggles 1000A. At least in the illustrated embodiment, the storage device 1008 includes, among other components, an object detection application and/or module 1102, a virtual space creation application and/or module 1104, and rendering application and/or module 1106 similar to the object detection application and/or module 202, virtual space creation application and/or module 204, and rendering application and/or module 206 stored on the storage device(s) 108 discussed with reference to FIG. 2.

With reference to FIG. 12, FIG. 12 is a schematic block diagram of one embodiment of a processor 1010 included in the AR glasses and/or goggles 1000A. At least in the illustrated embodiment, the processor 1010 includes, among other components, an object detection application and/or module 1202, a virtual space creation application and/or module 1204, and a rendering application and/or module 1206 similar to the object detection application and/or module 302, virtual space creation application and/or module 304, and rendering application and/or module 306 stored on the processor 110 discussed with reference to FIG. 3. As such, the object detection application and/or module 1102/1202, virtual space creation application and/or module 1104/1204, and rendering application and/or module 1206/1206 executed by the processor 1010 can be stored on and executed from a memory device 1008 and/or from the processor 1010.

With reference to FIG. 10B, FIG. 10B is a block diagram of another embodiment of AR glasses and/or goggles 1000B capable of operating/functioning in a passthrough mode. The MR glasses and/or goggles 400B include, among other components, a camera 402, a display 404, one or more input devices 406, one or more memory devices 408, and a processor 410 coupled to and/or in communication with one another via a bus 412, similar to the camera 102, display 104, input device(s) 106, memory device(s) 108, processor 110, and bus 112 discussed with reference to the digital headset 100A illustrated in and discussed with reference to FIG. 1A. Alternative to the MR glasses/goggles 400A, the processor 410 in the MR glasses/goggles 400B includes the memory device(s) 408 as opposed to the memory device(s) 408 of the virtual reality glasses/goggles 400A being a different device than and/or independent of the processor 410.

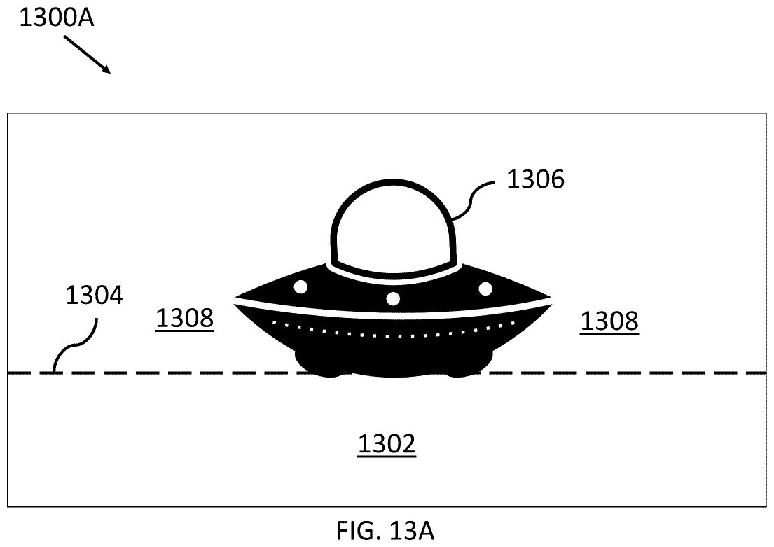

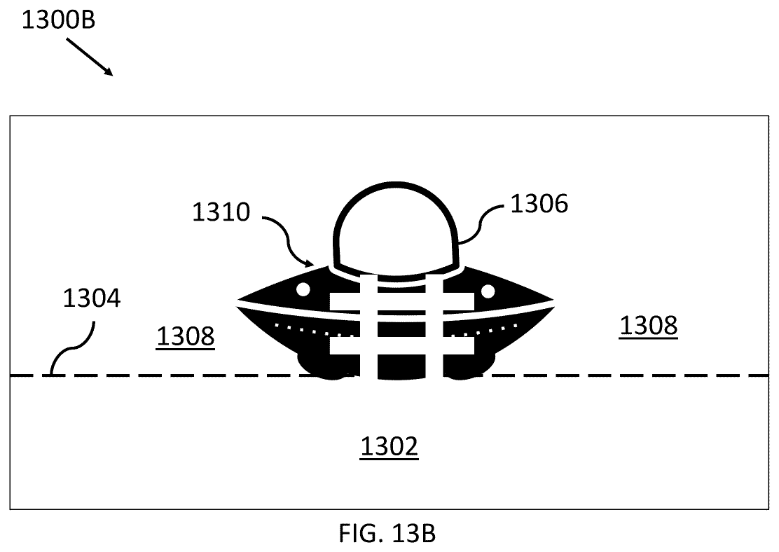

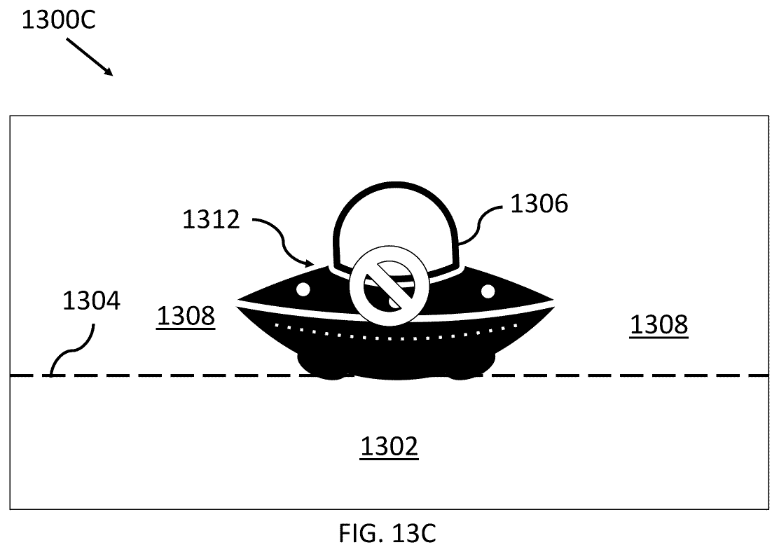

FIGS. 13A through 13C illustrate example operations of at least some embodiments of systems, methods, and computer program products for rendering a partial virtual boundary and/or one or more portions of a virtual boundary representing the boundary of a virtual space or safe space. The operations 1300A illustrated in FIG. 13A show an example embodiment of a virtual space 1302 when a user is within the virtual space 1302 and not approaching a boundary 1304 of the virtual space 1302 and/or is not proximate to the boundary 1304 of the virtual space 1302.

The virtual space 1302 can be created using any of embodiment of an object detection application/module (e.g., object detection application/module 202, 302, 502, 602, 802, 902, 1102, or 1202) and/or a virtual space creation application/module (e.g., virtual space application/module 204, 304, 504, 604, 804, 904, 1104, or 1204) discussed elsewhere herein. At least in the illustrated example embodiment, the virtual space 1302 is defined by the virtual boundary 1304 and includes a virtual object 1306 located along and/or at/proximate to the boundary 1304.

In certain embodiments, the virtual object 1306 is permanently and/or consistently rendered when the virtual object 1306 is within the field of view of the user. In additional or alternative embodiments, the virtual object 1306 can be located in front of and/or cover a real-world object (not shown) located/present in the real-world environment 1308 adjacent to the virtual space 1302 such that the real-world object is obscured and/or hidden by the virtual object 1306 or otherwise not visible by the user.

The virtual object 1306 may be any suitable object and/or type of object that can be virtually rendered. In the illustrated example embodiment, the virtual object 1306 is a virtual unidentified flying object (UFO), although other objects and/or types of objects that can be virtually rendered are possible, each of which is contemplated herein, and the various embodiments are not limited to virtual object 1306 and/or a virtual UFO.

While the example embodiment shows a single virtual object 1306 (e.g., a virtual UFO), the various embodiments are not limited to one virtual object 1306 being rendered along and/or at/proximate to a boundary 1304 of a virtual space 1302. That is, the various embodiments can include any suitable quantity of virtual objects 1306 being rendered along and/or at/proximate to a boundary 1304 of a virtual space 1302, any number (e.g., greater than or equal to zero (0)) of which may be obscuring/hiding a real-world object and/or any number (e.g., greater than or equal to zero (0)) of which may not be obscuring/hiding a real-world object.

FIG. 13B shows the operations 1300B of one example embodiment of the virtual space 1302 when the user is within the virtual space 1302 and is approaching the boundary 1304 and/or is proximate to the boundary 1304 of the virtual space 1302. At least in the illustrated embodiment, a portion of a virtual boundary 1310 and/or a partial virtual boundary 1310 is rendered in response to the user approaching the boundary 1304 and/or being proximate to the boundary 1304.

The portion of the virtual boundary 1310 and/or the partial virtual boundary 1310 can be rendered using any of embodiment of a rendering application/module (e.g., rendering application/module 206, 306, 506, 606, 806, 906, 1106, or 1206) discussed elsewhere herein. The portion of the virtual boundary 1310 and/or the partial virtual boundary 1310 can be rendered using any suitable virtual partial representation of a boundary 1310 and/or representation of a portion of a virtual boundary 1310 that is known or developed in the future. At least in the illustrated example embodiment, the rendered portion of the virtual boundary 1310 and/or the rendered partial virtual boundary 1310 includes a grid, which can include and/or be referred to as a visual grid or safe space boundary grid.

The rendered portion of the virtual boundary 1310 and/or the rendered partial virtual boundary 1310 can cover an entirety or any suitable portion(s) of the virtual object 1306. Here, the rendered portion of the virtual boundary 1310 and/or the rendered partial virtual boundary 1310 covers a portion of the virtual object 1306 (e.g., a portion of the virtual UFO).

In some embodiment, the rendered portion of the virtual boundary 1310 and/or the rendered partial virtual boundary 1310 does not extend beyond the borders of the virtual object 1306 (e.g., the borders of the virtual UFO) and/or is contained wholly within the borders of the virtual object 1306 such that the portion of the virtual boundary 1310 and/or the partial virtual boundary 1310 is not rendered along/at one or more other portions of the boundary 1304. In other embodiments, the rendered portion of the virtual boundary 1310 and/or the rendered partial virtual boundary 1310 can extend beyond the border of the virtual object 1306 provided that at least a portion of the boundary 1304 is clear and/or free from having the virtual boundary 1310 rendered thereon.

The portion of the virtual boundary 1310 and/or the partial virtual boundary 1310 can be rendered for any suitable amount of time in response to the user approaching the boundary 1304 and/or being proximate to the boundary 1304. In certain embodiments, the portion of the virtual boundary 1310 and/or the partial virtual boundary 1310 is constantly and/or consistently rendered when the user is approaching the boundary 1304 and/or located proximate to the boundary 1304. In additional or alternative embodiments, the portion of the virtual boundary 1310 and/or the partial virtual boundary 1310 is temporarily rendered and/or rendered for a predetermined amount of time when the user is approaching the boundary 1034 and/or located proximate to the boundary 1304, which predetermined amount of time can include any suitable amount of time that can enable the user to see the portion of the virtual boundary 1310 and/or the partial virtual boundary 1310 and/or not be distracted by the portion of the virtual boundary 1310 and/or the partial virtual boundary 1310 being rendered.

In addition, the portion of the virtual boundary 1310 and/or the partial virtual boundary 1310 is no longer rendered in response to the user moving away from the boundary 1304 and/or no longer being at/proximate to the boundary 1304. Alternatively, or additionally, the portion of the virtual boundary 1310 and/or the partial virtual boundary 1310 is no longer rendered in response to the expiration of a predetermined amount of time.

FIG. 13C shows the operations 1300C of another example embodiment of the virtual space 1302 when the user is within the virtual space 1302 and is approaching the boundary 1304 of the virtual space 1302 and/or is proximate to the virtual boundary 1304. At least in the illustrated embodiment, a visual cue 1312 is rendered in response to the user approaching the boundary 1304 and/or being proximate to the boundary 1304.

The visual cue 1312 can be rendered using any of embodiment of a rendering application/module (e.g., rendering application/module 206, 306, 506, 606, 806, 906, 1106, or 1206) discussed elsewhere herein. The visual cue 1312 can include any suitable visual cue that is known or developed in the future. At least in the illustrated example embodiment, the rendered visual cue includes a do not enter or negative symbol, although any other suitable symbols, types of symbols, visual cues, and/or types of visual cues is/are possible, each of which is contemplated herein.

The visual cue 1312 can cover an entirety or any suitable portion(s) of the virtual object 1306 (e.g., a virtual UFO). Here, the rendered visual cue 1312 covers a portion of the virtual object 1306.

In some embodiments, the rendered visual cue 1312 does not extend beyond the borders of the virtual object 1306 and/or is contained wholly within the virtual object 1306 such that the visual cue 1312 is not rendered along/at one or more other portions of the boundary 1304. In other embodiments, the rendered visual cue 1312 can extend beyond the border of the virtual object 1306 provided that at least a portion of the boundary 1304 is clear and/or free from having the visual cue 1312 rendered thereon.

The visual cue 1312 can be rendered for any suitable amount of time in response to the user approaching the boundary 1034 and/or being proximate to the boundary 1304. In certain embodiments, the visual cue 1312 is constantly and/or consistently rendered in response to the user approaching the boundary 1304 and/or being located proximate to the boundary 1304. In additional or alternative embodiments, the visual cue 1312 is temporarily rendered and/or rendered for a predetermined amount of time in response to the user approaching the boundary 1304 and/or being located proximate to the boundary 1304, which predetermined amount of time can include any suitable amount of time that can enable the user to see the visual cue 1312 and/or not be distracted by the visual cue 1312 being rendered.

In addition, the visual cue 1312 is no longer rendered in response to the user moving away from the boundary 1304 and/or no longer being at/proximate to the boundary 1304. Alternatively, or additionally, the visual cue 1312 is no longer rendered in response to the expiration of a predetermined amount of time, which can include any suitable amount of time.

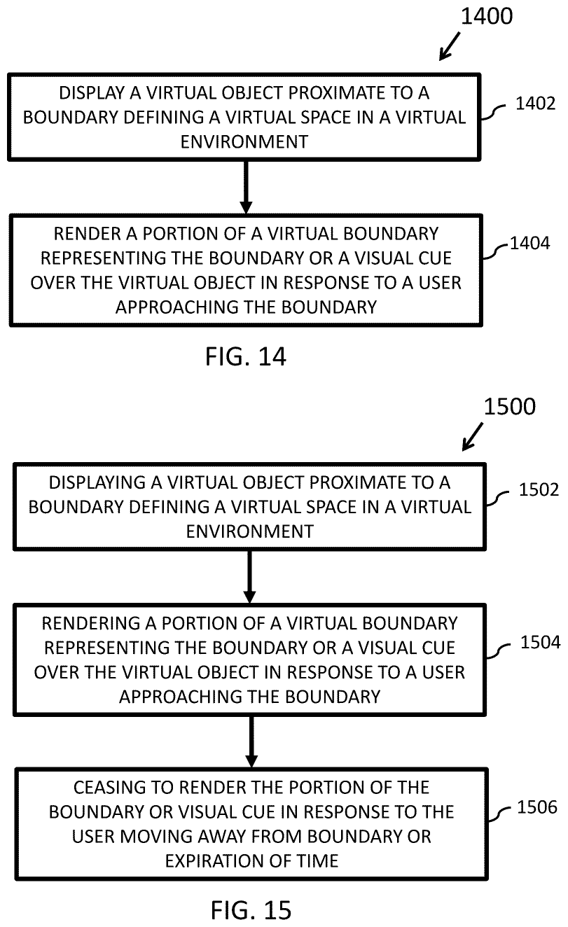

Referring to FIG. 14, FIG. 14 is a schematic flow chart diagram illustrating one embodiment of a method 1400 that can render a partial boundary of a virtual space. At least in the illustrated embodiment, the method 1400 can begin by a processor (e.g., processor 110) displaying a virtual object (e.g., virtual object 1306) along and/or at/proximate to a boundary (e.g., boundary 1304) (block 1402).

The method 1400 further includes the processor 110 rendering a portion of a virtual boundary/partial virtual boundary (e.g., a portion of the virtual boundary 1034 and/or the partial virtual boundary 1310) or a visual cue (e.g., visual cue 1312) over the virtual object 1306 in response to the user approaching the boundary 1304 and/or being proximate to the boundary 1304 (block 1404). The portion of the virtual boundary 1310/partial virtual boundary 1310 or visual cue 1312 may include any of the embodiments of a portion of the virtual boundary 1310/partial virtual boundary 1310 or visual cue 1312 discussed elsewhere herein.

The portion of the virtual boundary 1310/partial virtual boundary 1310 or visual cue 1312 may be rendered over the virtual object 1306 in any manner discussed elsewhere herein. Further, the portion of the virtual boundary 1310/partial virtual boundary 1310 or visual cue 1312 may be rendered over the virtual object 1306 for any suitable amount of time (e.g., consistent, temporary, etc.), as discussed elsewhere herein.

With reference to FIG. 15, FIG. 15 is a schematic flow chart diagram illustrating another embodiment of a method 1500 that can render a partial boundary of a virtual space. At least in the illustrated embodiment, the method 1500 can begin by a processor (e.g., processor 110) displaying a virtual object (e.g., virtual object 1306) along and/or at/proximate to a boundary (e.g., boundary 1304) (block 1502).

The method 1500 further includes the processor 110 rendering a portion of a boundary/partial boundary (e.g., portion of the virtual boundary 1310/partial virtual boundary 1310) or a visual cue (e.g., visual cue 1312) over the virtual object 1306 in response to the user approaching the boundary 1304 and/or being proximate to the boundary 1304 (block 1504). The portion of the virtual boundary 1310/partial virtual boundary 1310 or visual cue 1312 may include any of the embodiments of a portion of the virtual boundary 1310/partial virtual boundary 1310 or visual cue 1312 discussed elsewhere herein.

The portion of the virtual boundary 1310/partial virtual boundary 1310 or visual cue 1312 may be rendered over the virtual object 1306 in any manner discussed elsewhere herein. Further, the portion of the virtual boundary 1310/partial virtual boundary 1310 or visual cue 1312 may be rendered over the virtual object 1306 for any amount of time (e.g., consistent, temporary, etc.), as discussed elsewhere herein.

In various embodiments, the method 1500 further includes ceasing to render the portion of the virtual boundary 1310/partial virtual boundary 1310 or visual cue 1312 in response to the user moving away from the boundary 1304 and/or no longer being proximate to the boundary 1304 or expiration of a predetermined amount of time (block 1506). The expiration of the predetermined amount of time may include any suitable amount of time that can enable the user to see the portion of the virtual boundary 1310/partial virtual boundary 1310 or visual cue 1312 and/or not be distracted by the portion of the virtual boundary 1310/partial virtual boundary 1310 or visual cue 1312 being rendered.

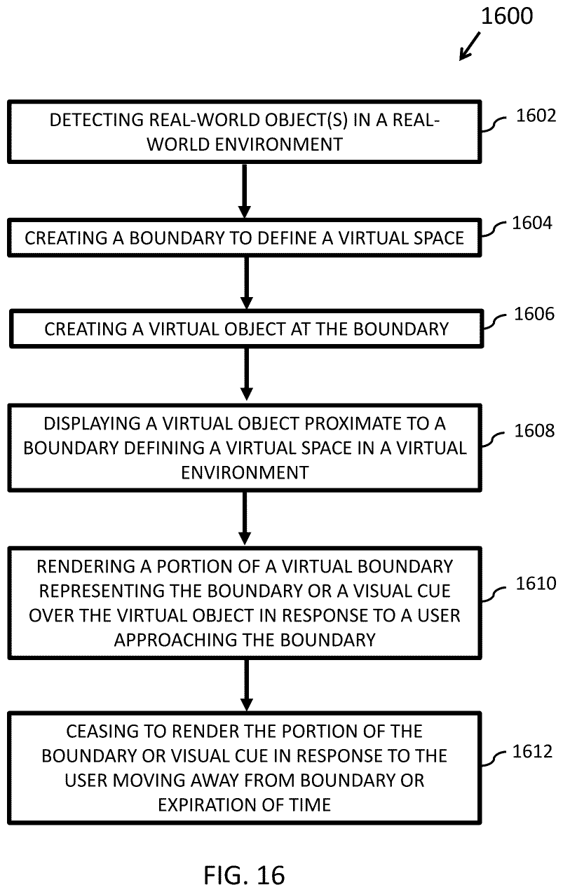

Referring to FIG. 16, FIG. 16 is a schematic flow chart diagram illustrating yet another embodiment of a method 1600 that can render a partial boundary of a virtual space. At least in the illustrated embodiment, the method 1600 can begin by a processor (e.g., processor 110) detecting one or more real-world objects in a real-world environment (e.g., real-world environment 1308) (block 1602).

The real-world object(s) may be detected using any suitable technique/method that is known or developed in the future. In some embodiments, the real-world object(s) is/are detected using a sensor (e.g., a camera 102), as discussed elsewhere herein.

The method 1600 further includes creating a boundary (e.g., boundary 1304) to define a virtual space (e.g., virtual space 1302) (block 1604). The boundary 1304 may be created using any of the embodiment of an object detection application/module (e.g., object detection application/module 202, 302, 502, 602, 802, 902, 1102, or 1202) and/or a virtual space creation application/module (e.g., virtual space application/module 204, 304, 504, 604, 804, 904, 1104, or 1204) discussed elsewhere herein.

In various embodiments, the method 1600 further includes creating one or more virtual objects (e.g., virtual object 1306) along and/or at/proximate to the boundary 1304 (block 1606) and displaying the virtual object 1306 along and/or at/proximate to the boundary 1304 (block 1608). The virtual object 1306 can be created using any of embodiment of the virtual space creation application/module (e.g., virtual space application/module 204, 304, 504, 604, 804, 904, 1104, or 1204) discussed elsewhere herein. Similarly, the virtual object 1306 can be display in accordance with any embodiment discussed elsewhere herein.

The method 1600, in various embodiments, further includes the processor 110 rendering a portion of a virtual boundary and/or a partial virtual boundary (e.g., portion of the virtual boundary 1310/partial virtual boundary 1310) or a visual cue (e.g., visual cue 1312) over the virtual object 1306 in response to the user approaching the boundary 1304 and/or being proximate to the boundary 1304 (block 1610). The portion of the virtual boundary 1310/partial virtual boundary 1310 or visual cue 1312 may include any of the embodiments of a portion of the virtual boundary 1310/partial virtual boundary 1310 or visual cue 1312 discussed elsewhere herein.

The portion of the virtual boundary 1310/partial virtual boundary 1310 or visual cue 1312 may be rendered over the virtual object 1306 in any manner discussed elsewhere herein. Further, the portion of the virtual boundary 1310/partial virtual boundary 1310 or visual cue 1312 may be rendered over the virtual object 1306 for any amount of time (e.g., consistent, temporary, etc.), as discussed elsewhere herein.

In various embodiments, the method 1600 further includes ceasing to render the portion of the virtual boundary 1310/partial virtual boundary 1310 or visual cue 1312 in response to the user moving away from the boundary 1304 and/or no longer being proximate to the boundary 1304 or expiration of a predetermined amount of time (block 1612). The expiration of the predetermined amount of time may include any suitable amount of time that can enable the user to see the portion of the virtual boundary 1310/partial virtual boundary 1310 or visual cue 1312 and/or not be distracted by the portion of the virtual boundary 1310/partial virtual boundary 1310 or visual cue 1312 being rendered.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system, comprising:
an apparatus including a processor and a memory coupled to the processor;
wherein the memory comprises instructions executable by the processor to cause the apparatus to:
display a virtual object proximate to a boundary of a virtual space within a mixed reality environment, and
render an indicator representing the boundary over the virtual object in response to a user approaching the boundary,
wherein the indicator is not rendered in the mixed reality environment beyond being rendered over the virtual object in response to the user approaching the boundary.

2. The system of claim 1, wherein the indicator is rendered one of for a predetermined amount of time or consistently rendered in response to the user approaching the boundary.

3. The system of claim 1, wherein the indicator is not rendered over the boundary in response to the user approaching the boundary.

4. The system of claim 1, wherein the indicator comprises a portion of a virtual boundary.

5. The system of claim 4, wherein the portion of the virtual boundary comprises a portion of a grid.

6. The system of claim 1, wherein the indicator comprises a visual cue.

7. The system of claim 1, wherein the apparatus comprises a mixed reality headset.

8. A method, comprising:
displaying, by a processor on a headset, a virtual object proximate to a boundary of a virtual space within a mixed reality environment; and
rendering an indicator representing the boundary over the virtual object in response to a user approaching the boundary,
wherein the indicator is not rendered in the mixed reality environment beyond being rendered over the virtual object in response to the user approaching the boundary.

9. The method of claim 8, wherein rendering the indicator comprises rendering the indicator one of for a predetermined amount of time or consistently rendering the indicator in response to the user approaching the boundary.

10. The method of claim 8, wherein the indicator is not rendered over the boundary in response to the user approaching the boundary.

11. The method of claim 8, wherein the indicator comprises a portion of a virtual boundary.

12. The method of claim 11, wherein the portion of the virtual boundary comprises a portion of a grid.

13. The method of claim 8, wherein the indicator comprises a visual cue.

14. The method of claim 8, wherein the headset comprises a mixed reality headset.

15. A computer program product comprising a computer-readable storage device including code embodied therewith, the code executable by a processor to cause the processor to:
display, on a headset, a virtual object proximate to a boundary of a virtual space within a mixed reality environment, and
render an indicator representing the boundary over the virtual object in response to a user approaching the boundary,
wherein the indicator is not rendered in the mixed reality environment beyond being rendered over the virtual object in response to the user approaching the boundary.

16. The computer program product of claim 15, wherein rendering the indicator comprises rendering the indicator one of for a predetermined amount of time or consistently rendering the indicator in response to the user approaching the boundary.

17. The computer program product of claim 15, wherein the indicator is not rendered over the boundary in response to the user approaching the boundary.

18. The computer program product of claim 15, wherein the indicator comprises one or a portion of a virtual boundary or a visual cue.

19. The computer program product of claim 18, wherein:
the indicator comprises the portion of the virtual boundary; and
the portion of the virtual boundary comprises a portion of a grid.

20. The computer program product of claim 15, wherein the headset comprises a mixed reality headset.
